(19) United States
(12) Patent Application Publication
(10) Pub. No.: US 2018/0131899 A1
(43) Pub. Date: May 10, 2018

(54) COMMUNICATION TERMINAL AND TOOL INSTALLED ON MOBILE TERMINAL

(71) Applicant: AINEMO INC, Beijing (CN)

(72) Inventor: Chenfeng SONG, Las Vegas, NV (US)

(73) Assignee: AINEMO INC., Beijing (CN)

(21) Appl. No.: 15/326,246

(22) PCT Filed: Sep. 15, 2014
(86) PCT No.: PCT/CN2014/086577

§ 371 Date: Nov. 6, 2017

(30) Foreign Application Priority Data
Jul. 15, 2014 (CN) 201410337297.0

(51) Int. Cl. H04N 7/14; G06K 9/00; H04M 3/22; H04L 29/06

(52) U.S. Cl. CPC H04N 7/141; G06K 9/00288; H04M 2203/6054; H04L 65/1069; H04M 3/2281

(57) ABSTRACT

Disclosed are a communication terminal and a tool installed on a mobile terminal. The communication terminal comprises a camera, an audio capturing unit, and a transceiver. The transceiver responds to a person or a specific person, a specific action, or an abnormality identified in a video and audio captured by the camera and the audio capturing unit. Information of a currently available network of a trusted user is acquired, and, the transceiver transmits reminder information to the trusted user via a corresponding network on the basis of the acquired information of the currently available network of the trusted user. Compared with the prior art, the present invention allows, regardless of the type of network environment in which a monitoring-side user is located, a monitored terminal to always transmit timely a reminder to the monitoring-side user, and allows the monitoring side to always connect actively to the monitored terminal in any network environment to engage in two-way video communication.

This application claims the benefit of a Chinese patent application No. 201410337297.0 filed on Jul. 15, 2014, with the title “COMMUNICATION TERMINAL AND TOOL INSTALLED ON MOBILE TERMINAL”; the entire content of which is incorporated herein by reference.

### TECHNICAL FIELD

The present invention relates to communication technologies, and in particular, to a communication terminal and a device installed in the mobile terminal.

### BACKGROUND

Existing communication terminals can only provide communication services, but cannot provide functions for monitoring and automatically notifying the user side, such as a stranger coming home, a sudden fall of an elderly person, a leak in a bathroom n hose, and the like. For users on the monitoring side, users need to be aware of the occurrence of these events in time in order to respond promptly to these events. In addition, even if the user on the monitoring side is notified when these events occur, the user on the monitoring side may not receive the notification due to network conditions or the like.

Conversely, this is also true when the monitoring side user calls the communication terminal. Due to changes in network conditions, communication interruptions often occur, so that the user on the monitoring side has to call the communication terminal manually again.

### SUMMARY

One of the technical problems to be solved by the present invention is to enable a terminal on the monitored side to send a notification to the user on the monitoring side in time, regardless of the network environment in which the user on the monitoring side is located.

According to one embodiment of an aspect of the present invention, there is provided a communication terminal comprising a video capture unit and an audio capture unit and a transceiver, wherein when identifying a person, a particular person, a specific action, or an abnormal condition from a video and an audio captured by the video capture unit and the audio capture unit, the transceiver acquires information of a currently available network of trusted users, and sends the notification information to the trusted user over the corresponding network based on the acquired information of the currently available network of the trusted user.

According to an embodiment of the present invention, the notification information is transmitted to the trusted user over the telecommunication network if the information of the currently available network of the trusted user acquired by the transceiver indicates that the IP network is available.

According to an embodiment of the present invention, the notification information is transmitted to the trusted user over the IP network if the information of the currently available network of the trusted user acquired by the transceiver indicates that the IP network is not availably but the telecommunication network is available.

According to an embodiment of the present invention, in response to receiving the first connection request through the first network from the trusted user, the transceiver automatically issues a reply to the connection request thereby automatically establishing the first communication with the trusted user over the first network.

According to an embodiment of the present invention, in the event of interruption of the first communication with the trusted user over the first network, if the transceiver receives the second communication connection request from the trusted user over the second network, then automatically sends a reply to the connection request to automatically establish a second communication with the trusted user through the second network.

Preferably, the communication terminal provided by the present invention further comprises a display and a speaker, wherein during communication with the trusted user, in case the transceiver establishes IP communication or 3G/4G communication with the trusted user, the is used to display the video from the trusted user received by the transceiver and the display is used to display the video from the trusted user received by the transceiver and the speaker is used to output the audio received from the transceiver; and the speaker is used to output the audio from the trusted user received by the transceiver in case the transceiver establishes 2G communication with the trusted user.

According to an embodiment of the present invention, in the case of communication with the trusted user, in a case where the transceiver establishes IP communication or 3G/4G communication with the trusted user, the transceiver sends the video and audio captured by the video capture unit and the audio capture unit to the trusted user: in the case where the transceiver establishes 2G communication with the trusted user, the transceiver only transmits the audio captured by the audio capture unit to the trusted user.

According to an embodiment of the present invention, the display simultaneously displays videos from a plurality of trusted parties when the transceiver simultaneously establishes IP or 3G/4G communication with a plurality of trusted users.

According to an embodiment of the present invention, in response to the one or more videos of the plurality of trusted users being selected, the transceiver disconnects with the trusted users corresponding to the one or more selected videos, or the speaker does not output the voice of trusted users corresponding to the one or more videos.

According to an embodiment of the present invention, the video of the selected rusted user becomes an enlarged main screen in response to a selection of one of the videos of the plurality of trusted users.

According to an embodiment of the present invention, the person or the specific person is identified based on one or more of face recognition, height recognition, voice recognition.

According to an embodiment of the present invention, the communication terminal provided by the present invention further comprising a depth sensor, the specific action is identified by according to video and audio captured by the video capture unit and the audio capture unit respectively and the depth sensed by the depth sensor.

According to an embodiment of the present invention, said abnormal condition is identified by recognizing one or more of: dramatic changes in the video captured by the video capture unit; audio captured by the audio capture unit is above a particular threshold; drastic changes in the audio captured by the audio capture unit; a predetermined event based on video and audio captured by the video capture unit and the audio capture unit respectively, wherein a model of the predetermined event has been established in advance; and the video and audio captured respectively by the video capture unit and the audio capture are searched for events matching the established model to identify a predetermined event.

According to an embodiment of the present invention, the communication terminal provided by the present invention further comprising: a rotation means for rotating the video capture unit.

According to an embodiment of the present invention, in response to identifying one of the following elements in the video and audio respectively captured from the video capture unit and the audio capture unit, the rotation means rotates the video capture unit in the direction of facing the identified element: person or specific person; specific action; and abnormal condition.

According to an embodiment of the present invention, the communication terminal provided by the present invention further comprises a light sensor for sensing ambient light changes in the surroundings of the communication terminal, wherein the display brightness of the display is adjusted to the sensed light changes.

According to an embodiment of the present invention, the present invention further provides a tool mounted on a mobile terminal, comprising:

a transmitting unit configured to detect a currently available network of the mobile terminal in response to a first trigger and to send a connection request for a specific communication terminal through a corresponding network according to a currently available network of the mobile terminal;

a receiving unit configured to receive an automatic reply from the specific communication terminal so as to automatically establish communication with the specific communication terminal, wherein

after establishing communication with the specific communication terminal, the transmitting unit detects again the currently available network of the mobile terminal in response to the network currently communicating with the specific communication terminal becoming unusable; basing on the currently available network of the mobile terminal, automatically sending the connection request for the specific communication terminal again through the corresponding network.

According to an embodiment of the present invention, if the transmitting unit detects that the IP network is available in response to the first trigger, the connection request for the specific communication terminal is transmitted over the IP network.

According to an embodiment of the present invention, if the transmitting unit, in response to the first trigger, detects that the IP network is unavailable but the telecommunication network is available, sending a connection request for the particular communication terminal over the telecommunication network.

According to an embodiment of the present invention, if the transmitting unit detects that the telecommunication network is available in response to the IP network currently in communication with the particular communication terminal becomes unavailable, the sending means automatically resend a connection request for the particular communication terminal over the telecommunication network.

According to an embodiment of the present invention, after establishing a communication link with the specific communication terminal, the transmitting unit, in response to establishing that the network currently communicating with the specific communication terminal is an IP network or a 3G network, transmitting video and audio captured by the mobile terminal to the specific communication terminal; and in response to the network currently communicating with the specific communication terminal being a 2G network, sending audio captured by the mobile terminal to the specific communication terminal.

According to an embodiment of the present invention, after establishing communication with said specific communication terminal, the receiving unit, in response to establishing that the network currently communicating with said specific communication terminal is an IP network or a 3G network, the specific communication terminal receiving video and audio from the specific communication terminal; in response to a network currently communicating with the specific communication terminal being a 2G network, the specific communication terminal receiving audio from the specific communication terminal.

Since the communication terminal provided by one embodiment of the present invention can send notification information to the network terminal based on currently available network information of the trusted user when a person, a specific person, a specific action, or an abnormal condition is identified. In this way, regardless of the current network status of the trusted user, timely notification can be made to what happened at the location of the communication terminal or/and the persons and/or anomalies that occurred, so as to more conveniently monitor the scene where the communication terminal is located. At the same time, the monitoring side can take the initiative to connect the monitored terminal under any network environment for two-way video communication. In addition, the transceiver supports both IP and telecom networks.

Since the communication terminal provided in one embodiment of the present invention sends the notification information to the trusted user over the IP network when knowing that the information of the currently available network of the trusted user indicates that the IP network is available. Therefore, when the IP network exists in the network information currently available to the trusted user, the notification information is preferentially sent to the trusted user through the IP network whenever an available telecommunication network exists at this moment. In fact, the communication terminal provided by the present invention is generally in an IP network environment (such as at home), and a trusted user (a monitoring user) may be in an IP network or may be in a 3G or 2G wireless communication network. In any case, due to the low cost of the IP network, it would firstly call trusted users over the IP network. If the call fails, then switch to other networks. The beneficial effect of reducing communication costs is achieved.

Since the communication terminal provided in one embodiment of the present invention automatically sends a response to the connection request of the trusted user whenever a connection request from a trusted user is received through any network. No need for the user near the communication terminal to manually confirm the connection request. In this way, for example, a trusted user (the user on the monitoring side) is firstly in a WiFi network and communicates with a communication terminal in the home. When a trusted user switches to a 3G network, the trusted client automatically initiates the connection request over the 3G network. Because home communication terminal designed to automatically answer. In this way, the 3G connection is reestablished and the communication from the IP network to the 3G network looks seamless to the users at home near the communication terminal. This achieves the beneficial effect that users beside the communication terminal can not feel the transition of the network environment where the trusted user is located.

In addition, since in some scenes, for example, a trusted user wants to notify the family member of one thing, the family members may be earnestly trying to knit a sweater or read a book without hearing the phone ringing. The communication terminal of one embodiment of the present invention automatically issues a reply to the connection request in response to receiving the first connection request through the first network from the trusted user. Thereby automatically establishing the first communication with the trusted user over the first network. In this way, the beneficial effect is achieved that the trusted user can still communicate with the person next to the communication terminal when the person next to the communication terminal can not answer the call or answers manually.

Since the communication terminal provided in one embodiment of the present invention may also display the video of the trusted user by the display in the case of establishing IP communication or 3G communication with the trusted user. This enhances the user's video interaction experience. Also, in the case of establishing 20 communication with a trusted user, the audio of the trusted user can also be output by the speaker. So that users can according to different communication networks, the freedom to choose different means of communication to communicate. Communication is more flexible.

Since the communication terminal provided in one embodiment of the present invention can also display videos of multiple trusted users at the same time when the transceiver establishes IP or 3G communication with multiple trusted users at the same time. So that the user of the communication terminal can perform video communication with multiple trusted users at the same time and simultaneously view the real-time scenes of multiple trusted users. Interactive experience better.

Since the communication terminal provided by one embodiment of the present invention may also be configured to disconnect the one or more videos corresponding to the one or more videos in response to one or more of the videos of the plurality of trusted users being selected. Or the speaker does not output the voice of a trusted user corresponding to the one video or the plurality of videos. This has achieved the beneficial effect of enabling the user at the side of the communication terminal to be more free to choose the object with which to communicate or talk. This can be the case, for example, where a user at a home communication terminal does not want certain trusted users to watch himself.

Since the communication terminal provided by one embodiment of the present invention may also be responsive to selecting one of the videos of the plurality of trusted users to be selected, the selected video is changed to an enlarged main screen. Thus, it is possible to realize the beneficial effect of the user beside the communication terminal not only knowing the status of all trusted users but also highlighting the communication with a trusted user at a certain time as needed. This is both universal and personal.

Since the communication terminal provided by one embodiment of the present invention can identify a person or a specific person based on one or more of face recognition, height recognition, and voice recognition. In other words, recognition is more accurate by comprehensively identifying people or specific people in many ways. In addition, the present invention can also be combined with a depth sensor to identify video and audio. The accuracy of recognition is significantly improved by the ability to sense depth and depth changes when recognizing three-dimensional objects and movements.

Since the communication terminal provided in one embodiment of the present invention can comprehensively identify abnormal conditions by: dramatic changes in video captured by the video capture unit; the audio capture unit capturing audio above a certain threshold; the dramatic changes in audio captured by the audio capture unit based on a variety of factors such as the video and audio captured respectively by the video capture unit and the audio capture unit, the predetermined event is identified. The accuracy of identifying abnormal conditions has increased.

In addition, since one embodiment of the present invention may further include a rotating device for rotating the video capturing unit, the video capturing unit captures the scene information more completely and flexibly when capturing the information.

Since the rotating device can be rotated according to the identified elements, the video capturing unit always faces the identified elements, so that the elements identified in the captured picture are clearer, and the captured content contains more useful information.

Since the communication terminal provided in accordance with one embodiment of the present invention further includes a light sensor, the display brightness of the display is adjusted according to ambient light changes so that the user can watch the video in different light with a better visual experience.

Since a tool installed in a mobile terminal according to an embodiment of the present invention is capable of detecting a currently available network of a mobile terminal in response to a first trigger. According to the currently available network of the mobile terminal, a connect on request for a specific communication terminal is transmitted through the corresponding network. In this way, a connection request can be initiated to a specific communication terminal (for example, at home) regardless of the network environment in which the trusted user (person carrying the mobile terminal) is located (for example, a wife environment or a 3G or 2G environment). Achieve the benefits of automatic communication.

In addition, since a tool installed on a mobile terminal of an embodiment of the present invention can detect the currently available network of the mobile terminal again in response to the network currently communicating with the specific communication terminal becoming unavailable. According to the currently available network of the mobile terminal, the connection request for the specific communication terminal is automatically sent through the corresponding network. In this way, it is possible to re-establish a connection, for example, by automatically detecting an available network and selecting a corresponding network, for example, when a user carrying a mobile terminal enters a coverage area of, for example, a 3G, 2G network by a WiFi network coverage area or the like. A user carrying a mobile terminal can automatically send a connection request to a specific communication terminal again without dialing manually again. This achieves the benefits of seamless handoff (no change to the network environment as perceived by the user carrying the mobile terminal).

In addition, in an embodiment of the present invention, it may be determined whether the network currently communicating with the specific communication terminal is an IP network or a 3G network or a 2G network, thus decide whether to conduct video and, audio communication with a specific communication terminal or only audio communication. Since the 2G network can not transmit video, first determine whether the network currently communicating with the specific communication terminal is an IP network or a 3G network or a 2G network, and then communicate accordingly, achieving the beneficial effect of not wasting communication resources.

It will be understood by those of ordinary skill in the art that although the following detailed description will be made regarding the illustrated embodiments and the accompanying drawings, the invention is not limited to these embodiments. Rather, the scope of the invention is broadly and is intended to limit the scope of the invention by the claims appended hereto.

### BRIEF DESCRIPTION OF THE DRAWINGS

Other features, objects, and advantages of the present invention will become apparent by reading the following detailed description of the non-limiting embodiments regarding the following drawings;

FIG. 1 shows a schematic block diagram of a communication terminal according to one embodiment of the invention;

FIG. 2 shows a schematic diagram of a communication terminal sending notification information to a trusted user through a switching network according to an embodiment of the present invention;

FIGS. 3 (a) and 3 (b) show respectively an external front view and an external side view of a communication terminal according to one embodiment of the present invention;

FIG. 4 shows a schematic block diagram of a tool mounted on a mobile terminal according to one embodiment of the present invention;

The same or similar reference numerals in the drawings refer to like or similar parts.

### DETAILED DESCRIPTION

The invention will now be described in further detail with reference to the accompanying drawings.

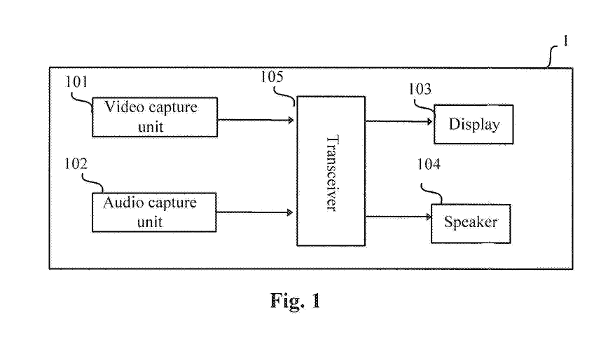

FIG. 1 shows a schematic block diagram of a communication terminal 1 according to one embodiment of the present invention. According to FIG. 1, the communication terminal 1 comprises a video capture unit 101, an audio capture unit 102 and a transceiver 105. The transceiver 105 identifies a person or a particular person, a particular action, or an abnormal condition in response to the audio and video captured from the video capture unit 101 and the audio capture unit 102. The transceiver 105 obtains the information of the currently available network of trusted users. Based on the acquired information of the currently available network of trusted users, the transceiver 105 sends the notification information to the trusted user over the corresponding network. It should be understood that the block diagram shown in FIG. 1 is for the purpose of illustration only and not as a limitation of the scope of the invention. In some cases, some units or devices may be added or subtracted as the case may be.

Herein, the video capture unit 101 is only used as an example. Any device having a video capture function may be applicable to the present invention, for example, a camera, which is not limited herein. The audio capture unit 102 includes any device having an audio capture function, such as a recording unit. The transceiver 105, for example, an antenna, may also be other transceiving devices, such as a built-in wireless transceiver module that supports both WiFi and telecommunication networks.

Here, the specific person may be preset by a user and stored in the communication terminal, such as an elderly person, a child in the home, or the like. Such anomalies include things such as stranger visits, misfires, cries, rattle, electrical accidents and the like. The trusted user may be preset by a user of the communication terminal, or may be set and adjusted by the communication terminal according to factors such as communication frequency. Such as setting friends and relatives who frequently communicate as trusted users. The currently available network information of the trusted user mainly includes currently available network types, network speeds, network addresses and the like. The types of networks include IP networks and telecommunications networks, and the telecommunications networks are divided into 3G and 2G. The sending the notification information to the trusted user may be performed by one or more manners such as a short message, a micro message, or a specific application message, which is not limited herein.

Here, the communication terminal 1 includes, but is not limited to, any electronic product that can perform human-computer interaction with a user through a touchpad, a voice control device, a remote control device or a keyboard, and includes, for example, a computer, a tablet computer (IPTV) and so on. Those skilled in the art should understand that, other user equipment that are applicable to the present invention should also be included in the protection scope of the present invention.

Typically, for the recognition of a person, when the communication terminal 1 switches from an unmanned environment to a human-presented environment, i.e., a human presence at a current location is recognized by the video capture unit 101 and the audio capture unit 102, the transceiver 105 actively sends the notification information to the trusted user on the other end through the corresponding network according to the acquired network information currently available to the trusted user to inform the trusted user on the other end of the current environment of the presence of a person.

Typically, for a particular person's identification, in realistic scenes, the nanny has been waiting at home, when a child Tom returned from school. The communication terminal 1 recognizes that the child is Tom through the video capture unit 101 and the audio capture unit 102. The transceiver 105 sends the notification information to the trusted user at the other end through the corresponding network in time or in real time according to the acquired network information currently available to the trusted user.

Typically, for the recognition of a particular action, through the video capture unit 101 and the audio capture unit 102, it recognizes actions such as an elderly fall, an action of a child dancing, and the like based on the captured video and audio. The transceiver 105 actively sends the notification information to the user at the other end through the corresponding network according to the acquired network information currently available to the trusted user.

Typically, for the identification of anomalies, based on video and audio captured by the video capture unit 101 and the audio capture unit 102, it identifies abnormal conditions such as stranger visits, fire, cries, noises, electrical accidents, and the like. The transceiver 105 actively sends the notification information to the user at the other end through the corresponding network according to the acquired network information currently available to the trusted user.

In one embodiment, if the information currently available for the trusted user acquired by the transceiver 105 indicates that the IP network is available. That is, in this case, regardless of whether the currently available network information of the trusted user includes other networks such as a telecommunications network in addition to the IP network, the notification information is preferentially sent to the trusted user over the IP network. Since the communication terminal 1 is usually located in a place such as a home, an office or the like, the IP network of the communication terminal 1 usually remains in an available state. Therefore, the communication terminal 1 directly sends the notification information to the trusted user through the IP network, so that the communication connection with the trusted user can be quickly established, so as to effectively improve the communication efficiency.

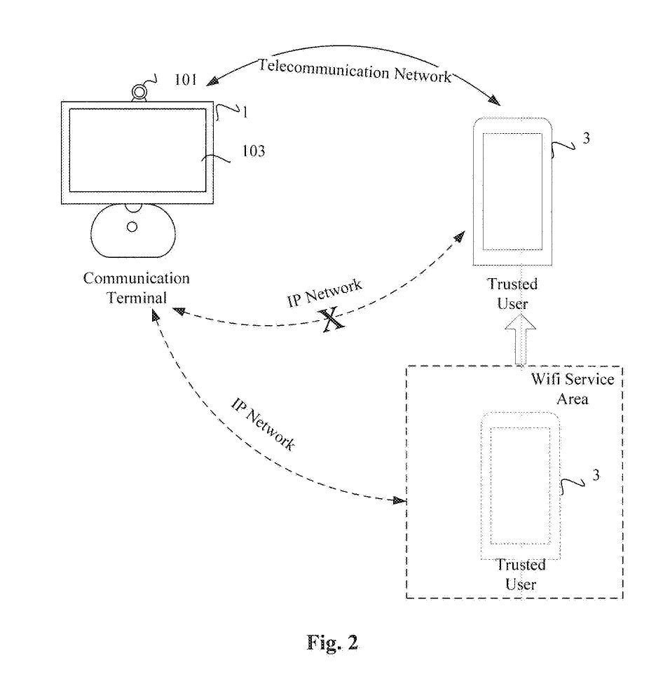

Please refer to FIG. 2, which shows a schematic diagram of a communication terminal sending notification information to a trusted user through a switching network according to an embodiment of the present invention. According to FIG. 2, initially, the trusted user is in the WiFi service area. The communication terminal learns that the trusted user is in the WiFi service area by, for example, checking the online status of the trusted user displayed on the IP server side (the online indication is in the WiFi service area and the online terminal is not in the WiFi service area). The notification information is sent to the trusted user over the IP network via the IP server. With trusted users moving, trusted users get out of the WiFi service area. That is, the trusted user's current IP network is unavailable (dotted line in FIG. 2, symbol “X” indicates unavailable) but the telecommunication network is available (solid line in FIG. 2). The communication terminal 1 acquires this information, for example, by checking the online status of the trusted users displayed on the IP server, and can also send notification to the trusted users directly via the telecommunication server via the telecommunication network or through the IP network to the telecommunication network (not shown). In this way, the communication terminal provided in this embodiment may be adapted to timely send the notification information to the trusted user in different network environments. The present invention avoids the restriction of single mode of communication that it can not communication in other network environment and thus notification information can not reach trusted users in a timely manner.

In addition, the communication terminal 1 provided by the present invention can automatically issue a reply to the connection request through the transceiver 105 in response to receiving the first connection request through the first network from the trusted user. Thereby automatically establishing the first communication with the trusted user over the first network. This automatically establishes communication with trusted users quickly and without human confirmation. This achieves the beneficial effect that the trusted user can still communicate with the person at the communication terminal when the person at the communication terminal can not answer the call or answer the call manually. In addition, the effect of monitoring independent of the will of the person beside the communication terminal is also achieved. The First network includes, for example, an IP network, a telecommunication network, and the like, which is not limited herein.

In addition, the transceiver 105 may also send a response to the connection request automatically if it receives a connection request from the trusted user for the second communication via the second network if the first communication via the first network is interrupted. Thereby automatically establishing a second communication with the trusted user over the second network. The second network is different in type from the first network. Of course, the second network may also include networks such as an IP network and telecommunications network, which are not limited herein. As a result when the communication terminal communicates with the trusted user, the communication terminal can seamlessly switch to the second network to communicate with the trusted user, even when the first network communication is interrupted, as long as the second network is available. Especially in some emergency situations, such as recording important numbers based on each other's dictation and communicating important issues, the continuity of communications is extremely important to the user. However, the communication terminal provided in this embodiment of the present invention can make the user completely feel that the process of switching from the interrupted first network communication to the second network to continue the communication, and the communication continuity is better. For example, in FIG. 2, the trusted user moves from the WiFi coverage area to the non-WiFi coverage area, and at this moment, the trusted user's mobile terminal automatically detects the change of the network environment, and automatically resends the connection request to the communication terminal through the telecommunication network. The communication terminal (for example, at home) receives the connection request and automatically answers to establish a new communication. For both end users, do not realize the middle of the process of switching, feeling the communication is seamless. This effect can not be achieved if the user next to the communication terminal needs to respond manually.

In one embodiment, the communication terminal 1 may further include a display 103 and a speaker 104. In the case of communicating with a trusted user, the display 103 is used to display the video from the trusted user received by the transceiver 105 in the event that the transceiver 105 establishes IP communication or 3G communication with the trusted user. The speaker 104 is used to output the audio received from the transceiver 105 by the trusted user. The display 103 may not only display the video of the trusted user, but also display other content such as an identifier corresponding to the video at the same time. For example, a video corresponding to the shortcut icon. With the transceiver 105 establishing 2G communication with a trusted user, the speaker 104 may output the audio from the trusted user received by the transceiver 105. Thereby, the communication terminal 1 can output the communication contents corresponding to the different communication methods. In the high communication speed of IP or 3G communication mode, the preferred use of strong interactive video communication site. In the 2G communication mode with lower communication speed, in order to maintain the communication quality, the audio communication which can save the traffic is preferred. Preferably, where the transceiver 105 simultaneously establishes IP or 3G communications with multiple trusted users, the display 103 simultaneously displays video from multiple trusted users. Just as the User of the communication terminal 1 has opened a window for communicating with plurality of trusted users. You can focus on the liveness of multiple trusted users simultaneously. Preferably, when the communication terminal 1 performs IP communication, 3G communication or 2G communication with a single trusted user, end-to-end direct communication is employed. When communicating with multiple users for IP communication, 3G communication or 2G communication, the server is used for communication. This flexible way of communication allows the communication terminal 1 to effectively avoid wasting server resources when communicating with a single user. And enables the communication terminal 1 to forward data through the server when communicating with a plurality of users, to transfer large amounts of data faster and more accurately.

Further, the transceiver 105 may further disconnect communications with trusted users corresponding to the one or more videos in response to one or more of the plurality of trusted users' videos being selected, or the speaker 104 does not output the sound of the trusted user corresponding to the one or more videos. Thereby, the user of the communication terminal can freely select the object of communication as required or freely select to hear or not hear the voice of the other party's user. In particular, the communication terminal 1 may also be responsive to selection of one of the plurality of trusted users' videos, the video of the selected trusted user becoming an enlarged main screen. Thereby highlighting the communication interaction between the user of the communication terminal 1 and the focused subject.

Corresponding to the process of receiving information by the communication terminal 1 described above, at the time of sending information, the communication to terminal 1 establishes an IP communication with a trusted user during the communication with the trusted user or 3G communication, the transceiver transmits the video and audio captured by the video capture unit 101, the audio capture unit 102 to the trusted user. In the event that the transceiver 105 establishes 2G communication with the trusted user, the transceiver transmits the audio captured by the audio capture unit 102 only to the trusted user. In summary, the communication terminal 1 can adjust the received or transmitted information types according to different networks. The type of information herein mainly refers to video and audio.

Among them, the identification of a person or a specific person by the communication terminal 1 may be identified based on one or more of face recognition, height recognition, voice recognition. Herein, the manner in which the communication terminal 1 recognizes a person or a specific person is not limited, and any device or unit having an identification person or a specific person, which is applicable to the present invention, should be included in the protection scope of the present invention, which is included here by reference.

In the case of recognition of people, because the pattern of the face is very similar, the vast majority of people are also within the specific height, the frequency of human voices are also within a specific range. Therefore, for example, when a certain area in the captured image is similar to the stored face pattern; and/or when the distance between the face detected by the position sensor; and/or when the depth sensor and the communication terminal 1 is determined to be within a specific range; and/or when the audio captured by the audio capturing unit 102 is also within a specific range, human presence can be identified.

In the case of identifying a specific person, the pattern and/or height and/or sound frequency of a specific person's face may be stored in the memory in advance. When a certain area in the captured image matches the stored pattern of the specific face; and/or when the distance between the specific face and the communication terminal 1 sensed by the position sensor; and/or when the depth sensor is determined that its height matches the stored height; and/or when the audio captured by the audio capture unit 102 matches the stored frequency of the specific human voice, the existence of a particular person can be identified.

Identifying people or the existence of a particular person can also be self-learning. For example, if a pattern in a captured image always appears at a certain frequency with the captured sound, a prompt can be displayed on the display. That is, a person has been identified. the user of the communication terminal 1 is invited to judge and name the identified person. If the user of the communication terminal 1 finds out that it is a recognition error, it is fed back on the display interface. Upon receipt of such feedback, no human or particular person is deemed present at the same time as this pattern in the next shot of the image appears coincident with such frequency of captured sound. In the self-learning mode, the pattern and/or height and/or sound frequency of the face of a particular person may also not be stored in advance in memory.

In addition, it is also possible to identify a person or a specific person on the basis of a wireless signal transmitted from a portable phone. For example, the communication terminal 1 is a Bluetooth device, and the trusted user's cell phone also has a Bluetooth wireless unit. When the communication terminal 1 recognizes that the Bluetooth wireless unit of a specific identity appears within a certain distance, it is considered that a specific person is identified.

Alternatively, the communication terminal 1 may also recognize a specific action based on the captured video and audio from the video capture unit 101 and the audio capture unit 102, such as identifying actions of elderly people to fall, actions of children dancing, and the like. Then the transceiver 105 actively sends the notification information to the trusted user at the other end.

Alternatively, the model may be artificially set in advance and set according to the set action. When a specific action matching a stored model is searched out from the video and audio captured by the video capture unit 101 and the audio capture unit 102, the transceiver 105 actively sends the notification information to the trusted user at the other end. For example, for an action like watching TV, create a model that identifies a person sitting on a couch, looks down the person's gaze, has an object, recognizes that the object is a television, and the person stays on television at least 10 seconds. If a person is detected from the image captured by the video capture unit 101 and then the person is detected to be sitting on the couch (the recognition of the sofa resembles face recognition can also be performed by pattern matching or the image of the person sitting on the sofa as a whole as an object for pattern matching recognition), and then detect the direction of the person's gaze, and then detect whether the object in the gaze direction of the person is a television (for example, the television is modeled as an object), and if so counts for 10 seconds.

Of course, the communication terminal 1 may also automatically create an action model by means of self-learning such as machine learning. For example, the communication terminal 1 extracts the action feature from the video and audio captured by the video capture unit 101, the audio capture unit 102, and establishes the action model based on the extracted feature. For example, one person found in the video and audio captured by the video capturing unit 101 and the audio capturing unit 102 finds himself sitting on the couch, having a television in the direction of the person's eyes and watching the event of the person staying on the television If the frequency exceeds the threshold for more than 10 seconds, this is considered as a model of a specific action. In this case, the motion model may not be stored in the database in advance, but a model of action is extracted from the video and audio captured from the video capture unit 101, the audio capture unit 102 in a learned manner.

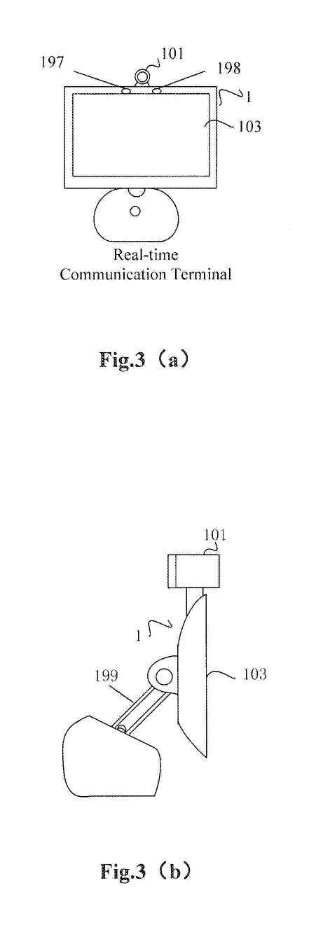

Referring to FIG. 3 (a), FIG. 3 (a) shows an external front view of the communication to terminal according to one embodiment of the present invention. According to FIG. 3 (a), in recognizing a specific action, the communication terminal 1 further includes a depth sensor 197 in order to recognize a specific action more accurately. The specific actions are collectively identified by the video capture unit 101 and the audio capture unit 102 as well as the depth sensor 197 by the captured video and audio as well as the sensed depth. Of course, in FIG. 3 (a), the location of the depth sensor 197 is for illustration only. It may also be located at other reasonable locations of the communication terminal 1 and is not limited herein. Similarly, the positions of other devices or components shown in FIG. 3 (a) are merely for illustration and will not be repeated here.

In identifying abnormal conditions, the communication terminal 1 can identify by recognizing one or more of: the dramatic change of the video captured by the video capture unit 101; audio above a certain threshold captured by audio capture unit 102; drastic changes in the audio captured by the audio capture unit 102; and predetermined events identified based on the video and audio respectively captured by the video capture unit 101 and the audio capture unit 102. The model of the predetermined event is established in advance and searches for the event matching the established model from the video and audio respectively captured by the video capturing unit 101 and the audio capturing unit 102. Thus identifying the scheduled event.

Optionally, the communication terminal 1 identifies a predetermined event based on the video capture unit 101 and the audio capture unit 102, wherein a model of the predetermined event has been established in advance. And then searches through the video and audio respectively captured by the video capturing unit 101 and the audio capturing unit 102 for an event matching the established model. Thus identifying the predetermined event. Here, the communication terminal 1 can automatically create a model of a predetermined event by way of self-learning such as machine learning. Typically, the communication terminal 1 extracts event features from the video and audio captured by the video capture unit 101 and the audio capture unit 102. Establishes a model of a predetermined event based on the extracted event features, classifies the various events and obtains training parameters, so as to identify the scheduled event.

Referring to FIG. 3 (b), FIG. 3 (b) shows an external side view of the communication terming according to one embodiment of the present invention. According to FIG. 3 (b), in order to capture audio and video in a multi-angle, multi-directional manner, the communication terminal 1 further comprises a rotation device 199 for rotating the video capture unit. Optionally, in order to capture more useful information when capturing information, one of the following elements is identified in response to video and audio captured respectively from the video capture unit 101 and the audio capture unit 102. The rotating device 199 rotates the video capture unit 101 in a direction facing the recognized element: person or specific person; specific action; abnormal condition.

Please refer to FIG. 3 (a), in order to enable a user to have a good visual experience when performing video communication or watching video in different light environments, the communication terminal 1 may further include a light sensor 198 for sensing the ambient light around the sensing communication terminal 1 changes. The display brightness of the display 103 is adjusted according to the sensed change of light.

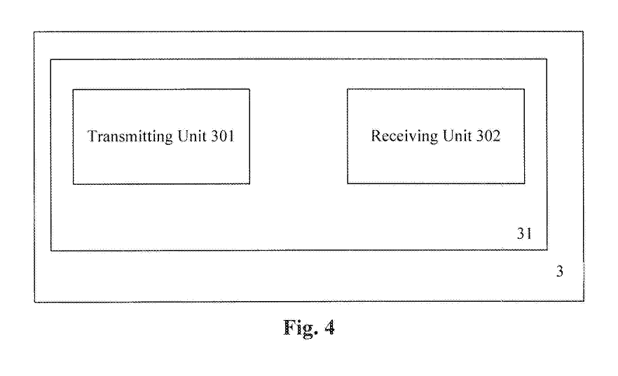

Please refer to FIG. 4, which shows a schematic block diagram of a tool 31 mounted on a mobile terminal 3 according to one embodiment of the present invention. According to FIG. 4, the tool 31 mounted on the mobile terminal 3 includes:

The transmitting unit 301 is configured to respond to the first trigger. Detecting the currently available network of the mobile terminal 3 and sending a connection request for the specific communication terminal through the corresponding network according to the currently available network of the mobile terminal 3;

The receiving unit 302 is configured to receive an automatic reply from the specific communication terminal. Thereby automatically establishing communication with the particular communication terminal, wherein

After establishing communication with the specific communication terminal, the transmitting unit 301 becomes unavailable in response to the network currently communicating with the specific communication terminal, detects the currently available network of the mobile terminal 3 again, and automatically sends the connection request for the specific communication terminal again through the corresponding network according to the currently available network of the mobile terminal 3.

The tool installed on the mobile terminal 3 is installed on the mobile terminal, such as in the form of an application, and displayed in the form of a corresponding application icon. Such as in response to the booting of the mobile terminal 3 or in response to running of the tool 31 after the mobile terminal 3 is powered on. The running is performed, for example, by any one or a combination of clicks, double-clicks, long presses, etc. The currently available network generally refers to an IP network, a telecommunications network, and the like. The specific communication terminal is not limited herein, and may refer to the communication terminal 1 described, above, or may refer to any other terminal having a communication function. Preferably, the specific communication terminal may be a terminal that has established a binding relationship with the mobile terminal 3 before the tool 31 detects the currently available network. Therefore, after the sending unit 301 detects the current network, the transmitting unit 301 directly sends a connection request to the target terminal that has established the binding relationship through the corresponding network.

As shown in FIG. 2, initially, the transmitting unit 301 detects that the IP network is available in response to the first trigger, and sends a connection request for a specific communication terminal through the IP network (of course, if the transmitting unit 301 detects the IP Network unavailable but telecommunications network available, sending connection request for a particular communication terminal over the telecommunications network). After receiving the automatic reply from the specific communication terminal, the mobile terminal 3 performs IP communication with the specific communication terminal. At this time, as shown in FIG. 2, the user (trusted user) carrying the mobile terminal 3 at the time of communication moves out of the WiFi service area. After detecting that the 3G network is available, for example, the transmitting unit 301 automatically sends a connection request (direct sending or 3G server) to a specific communication terminal again through the 3G network and receives an automatic response from the specific communication terminal to establish communication with the specific mobile terminal. As a result, the handover of the network is automatically performed at the time of connection, and for both users, it can not feel the connection request of the IP network is interrupted and the connection request is sent through the telecommunications network. Therefore, the continuous experience of communication is better.

Thus, in the case where the IP network is available, it is possible to send a connection request for a specific communication terminal preferentially through the IP network irrespective of whether other available types of networks such as a telecommunications network are also additionally stored, thereby making it possible to cost-effectively connect to a specific communication terminal that is typically located in a fixed location and placed in an IP network environment. Of course, even in the absence of an IP network, since the transmitting unit 301 of the present embodiment can easily send a connection request to a specific communication terminal even when the telecommunication network is detected.

After the tool provided in this embodiment establishes communication with the specific communication terminal, the transmitting unit 301 sends, in response to the network currently communicating with the specific communication terminal being an IP network or a 3G network. The specific communication terminal transmits the video and audio captured by the mobile terminal 3 and transmits the audio captured by the mobile terminal 3 to the specific communication terminal in response to the network currently communicating with the specific communication terminal being a 2G network.

Corresponding to the process of sending information by the tool 31 described above, upon reception of the information, after the communication with the specific communication terminal is established, the reception unit 302, in response to the network currently communicating with the specific communication terminal, is an IP network or a 3G network from which video and audio from the specific communication terminal are received; in response to a network currently communicating with the specific communication terminal being a 2G network, receiving, from the specific communication terminal, audio for specific communication terminal.

Those skilled in the art will recognize that the present invention may be implemented as a device, an apparatus, a method, or a computer program product. Therefore, the present disclosure may be embodied in the form of complete hardware, complete software, or a combination of hardware and software.

The flowcharts and block diagrams in the figures illustrate the architecture, functionality, and operation of possible implementations of systems, methods, and computer program products in accordance with various embodiments of the present invention. In this regard, each block of the flowchart illustrations or block diagrams, which may represent a module, a section of a program, or a portion of a code that includes one or more portions of a program for implementing specified logic functions Executable instructions. It should also be noted that in some alternative implementations, the functions noted in the blocks may occur out of the order noted in the figures. For example, two consecutive blocks may in fact be executed substantially in parallel, and sometimes they may be executed in the reverse order, depending on the function involved. It is also to be noted that each block of the block diagrams and/or flowchart illustrations, and combinations of blocks in the block diagrams and/or flowchart illustration, can be implemented by special purpose hardware-based systems that perform the specified functions or operations, or may be implemented using a combination of dedicated hardware and computer instructions.

It will be apparent to those skilled in the art that the present invention is not limited to the details of the foregoing exemplary embodiments, but that the present invention may be embodied in other specific forms without departing from the spirit or essential characteristics thereof. Thus, the present examples are to be considered in all respects as illustrative and not restrictive, the scope of the invention being indicated by the appended claims rather than by the foregoing description, and thus is intended to be included in the claims, all changes which come within the meaning and range of equivalency of the appended claims are intended to be embraced therein. Any reference signs in the claims should not be construed as limiting the claim involved.

1. A communication terminal comprising:
a video capture unit;
an audio capture unit; and
a transceiver, wherein when identifying a person, a particular person, a specific action, or an abnormal condition from a video and an audio captured by the video capture unit and the audio capture unit, the transceiver acquires information of a currently available network of trusted users, and sends the notification information to the trusted user over the corresponding network based on the acquired information of the currently available network of the trusted user.

2. The communication terminal according to claim 1, wherein the notification information is transmitted to the trusted user over the telecommunication network if the information of the currently available network of the trusted user acquired by the transceiver indicates that the IP network is available.

3. The communication terminal according to claim 1, wherein the notification information is transmitted to the trusted user over the IP network if the information of the currently available network of the trusted user acquired by the transceiver indicates that the IP network is not available but the telecommunication network is available.

4. The communication terminal according to claim 1, wherein in response to receiving the first connection request through the first network from the trusted user, the transceiver automatically issues a reply to the connection request thereby automatically establishing the first communication with the trusted user over the first network.

5. The communication terminal according to claim 1, wherein in the event of interruption of the first communication with the trusted user over the first network, if the transceiver receives the second communication connection request from the trusted user over the second network, then automatically sends a reply to the connection request to automatically establish a second communication with the trusted user through the second network.

6. The communication terminal according to claim 4, further comprising a display and a speaker, wherein during communication with the trusted user, in case the transceiver establishes IP communication or 3G communication with the trusted user, the display is used to display the video from the trusted user received by the transceiver and the speaker is used to output the audio received from the transceiver; and the speaker is used to output the audio from the trusted user received by the transceiver in case the transceiver establishes 2G communication with the trusted user.

7. The communication terminal according to claim 4, wherein in the case of communication with the trusted user, in a case where the transceiver establishes IP communication or 3G communication with the trusted user, the transceiver sends the video and audio captured by the video capture unit and the audio capture unit to the trusted user; in the case where the transceiver establishes 2G communication with the trusted user, the transceiver only transmits the audio captured by the audio capture unit to the trusted user.

8. The communication terminal according to claim 6, wherein the display simultaneously displays videos from a plurality of trusted parties when the transceiver simultaneously establishes IP or 3G communication with a plurality of trusted users.

9. The communication terminal according to claim 8, wherein in response to the one or more videos of the plurality of trusted users being selected, the transceiver disconnects with the trusted users corresponding to the one or more selected videos, or the speaker does not output the voice of trusted users corresponding to the one or more videos.

10. The communication terminal according to claim 8, wherein the video of the selected trusted user becomes an enlarged main screen in response to a selection of one of the videos of the plurality of trusted users.

11. The communication terminal according to claim 1, wherein the person or the specific person is identified based on one or more of face recognition, height recognition, voice recognition.

12. The communication terminal according to claim 1, further comprising a depth sensor, the specific action is identified by according to video and audio captured by the video capture unit and the audio capture unit respectively and the depth sensed by the depth sensor.

13. The communication terminal according to claim 1, wherein said abnormal condition is identified by recognizing one or more of:
dramatic changes in the video captured by the video capture unit;
audio captured by the audio capture unit is above a particular threshold;
drastic changes in the audio captured by the audio capture unit; and
a predetermined event based on video and audio captured by the video capture unit and the audio capture unit respectively, wherein a model of the predetermined event has been established in advance; and the video and audio captured respectively by the video capture unit and the audio capture are searched for events matching the established model to identify a predetermined event.

14. The communication terminal according to claim 1, further comprising: a rotation means for rotating the video capture unit.

15. The communication terminal according to claim 14, wherein in response to identifying one of the following elements in the video and audio respectively captured from the video capture unit and the audio capture unit, the rotation means rotates the video capture unit in the direction of facing the identified element:
a person or a specific person;
a specific action; and
an abnormal condition.

16. The communication terminal according to claim 6, further comprising a light sensor for sensing ambient light changes in the surroundings of the communication terminal, wherein the display brightness of the display is adjusted to the sensed light changes.

17. A tool mounted on a mobile terminal, comprising:
a transmitting unit configured to detect a currently available network of the mobile terminal in response to a first trigger and to send a connection request for a specific communication terminal through a corresponding network according to a currently available network of the mobile terminal; and
a receiving unit configured to receive an automatic reply from the specific communication terminal so as to automatically establish communication with the specific communication terminal, wherein
after establishing communication with the specific communication terminal, the transmitting unit detects again the currently available network of the mobile terminal in response to the network currently communicating with the specific communication terminal becoming unusable; basing on the currently available network of the mobile terminal, automatically sending the connection request for the specific communication terminal again through the corresponding network.

18. The tool according to claim 17, wherein if the transmitting unit detects that the IP network is available in response to the first trigger, the connection request for the specific communication terminal is transmitted over the IP network.

19. The tool according to claim 17, wherein if the transmitting unit, in response to the first trigger, detects that the IP network is unavailable but the telecommunication network is available, sending a connection request for the particular communication terminal over the telecommunication network.

20. The tool according to claim 17, wherein if the transmitting unit detects that the telecommunication network is available in response to the IP network currently in communication with the particular communication terminal becomes unavailable, the sending means automatically resend a connection request for the particular communication terminal over the telecommunication network.

21-22. (canceled)
